(19) United States
(12) Patent Application Publication
(10) Pub. No.: US 2022/0180504 A1
(43) Pub. Date: Jun. 9, 2022

(54) DEVICE FOR DETECTING A THREE-DIMENSIONAL STRUCTURE

(71) Applicant: SENSWORK GMBH, Burghausen (DE)

(72) Inventors: Rainer OBERGRUSSBERGER, Pleiskirchen (DE); Roman RIEGER, Teisendorf (DE); Sebastian MAYER, Burghausen (DE); Michael ZWIRGLMAIER, Reischach (DE); Daniel MÜLLER, Tussling (DE); Robert HÖCKETSTALLER, Burghausen (DE); Matthias DONAUBAUER, Munchen (DE)

(73) Assignee: SENSWORK GMBH, Burghausen (DE)

(21) Appl. No.: 17/426,100

(22) PCT Filed: Jan. 15, 2020
(86) PCT No.: PCT/EP2020/050945

§ 371 Date: Jul. 28, 2021

(30) Foreign Application Priority Data
Jan. 29, 2019 (DE) 10 2019 102 231.2
Feb. 20, 2019 (EP) 19158404.4

(51) Int. Cl. G06T 7/00; H04N 5/235; H04N 5/232; H04N 13/156; H04N 13/221

(52) U.S. Cl. CPC G06T 7/0006; H04N 5/2353; H04N 5/23299; G06T 2200/04; H04N 13/221; G06T 2207/30164; H04N 13/156

(57) ABSTRACT

The invention relates to a device for detecting a three-dimensional structure, comprising an imaging device, especially a camera, which is adjustable in the z-direction, a control device which is designed to record an image of a first plane and, after adjustment of the imaging device in the z-direction, to record an image of a second plane, and an evaluation device which is designed to interpolate a sub-plane between the first plane and the second plane.

The invention relates to a device for detecting a three-dimensional structure, comprising an imaging device, in particular a camera, which is adjustable in the z-direction, a control device which is designed to record an image of a first plane and, after adjustment of the imaging device in the z-direction, to record an image of a second plane.

Such devices are known in principle. They involve capturing different planes in order that a three-dimensional composite image may be obtained.

These devices find use, for example, in automated optical inspection processes for the purposes of quality assurance.

The quality assurance requirements imposed by industry on optical inspection processes are constantly increasing in respect of accuracy, speed and/or safety. Similarly, the optical processing of increasingly complex production parts is becoming more and more demanding.

Manufacturers of electronic and/or connector components, e.g. for the electrical and electronics industry, the automotive industry and/or in medical technology, even have to check the tiniest of drawing-related dimensions, such as coplanarity, 3D housing shapes and/or the vertical position of connector pins.

One quality feature that frequently has to be checked in the case of such objects is the height of the connector pins. Pins that are too short, broken and/or bent would be unable to make a proper connection to mating parts and thus unable to make electrical contact. Similarly, where a connector has several connector pins, it is usually necessary to ensure that they are coplanar. By coplanar here is meant that the pin tips all lie in one plane.

On account of the vast batch sizes, sometimes comprising several million modules, production cycle times are correspondingly short, more especially they are shorter than two seconds.

The inspection technology must not slow down the production cycle, and so high-speed, rugged and/or inline cameras for conducting three-dimensional inspections of the components are needed on the production lines. An inline camera is characterised in particular by a short scanning time, which is shorter than or equal to a typical automated production cycle.

Under the name ZFokus®, for example, there is a device for detecting three-dimensional structures available on the market that uses a method called depth from focus (DfF).

However, so far, ZFokus, is only capable of a scanning rate of three seconds, a fact which means that some industrial requirements cannot be met.

It is therefore an object of the invention to create a device as well as a method for detecting a three-dimensional structure at high scanning rates.

This object is solved by the device and the method of the independent claims.

In accordance with the invention, a three-dimensional structure is detected, e.g. a three-dimensional object. The object may, for example, be a mass-produced product, such as an electronic or connector component or both. These are usually produced in large volumes and must undergo quality assurance inspection within a short time.

For this purpose, the three-dimensional structure is detected. Preferably, this is achieved by automated means. Deviations can be detected in this regard. An object that fails to meet the specified criteria can then be removed, for example. A warning can also be generated should the number of objects with deviations prove excessive.

The device comprises an imaging device, in particular a camera, which is adjustable in the z-direction. Preferably, the camera is a 2D camera, especially one of high resolution. The device generates a 3D image through a combination of the 2D camera, the axis and associated software. The imaging device is designed in particular for wear-free, three-dimensional, inline quality control of small and/or very small components.

The imaging device can, in particular, have a field of view of at least 5 mm×5 mm, preferably of at least 10 mm×10 mm, e.g. of 12 mm×12 mm, 30 mm×24 mm or 30 mm×34 mm.

Lateral accuracy can, in particular, be 5 μm.

In particular, the camera can have a field of view of 2048×2048 pixels mono-chrome.

For example, the camera can have a resolution of at least 1, 5, 10, 15, 20, 25 or more megapixels.

In particular, the frame rate can be at least 50 fps, e.g. 72 fps, 80 fps, 86 fps or 92 fps. Higher frame rates are also conceivable at lower resolutions.

Preferably, the device operates in accordance with the DfF method. The term DfF describes a method by which, with the aid of a stack of images numbering at least two, preferably at least 3, 4, 5, 6, 7, 8, 9, 10, 20, 30, 40, 50, 60, 70, 80, 90, 100, 150, 200, 250, 300, 400, 500 or more images, different imaging conditions are used to calculate the distance between an object point and the camera on the basis of a focal setting.

As the DfF algorithm returns only discrete indices by way of height values, its accuracy in the z-direction is limited. Thus, in order that the true height may be assessed, it is necessary to establish a correlation between the z-index and the distances between the images. For example, a measuring probe, a linear scale and/or an electronic distance-measuring device may be provided for the purpose of determining the position.

The imaging device can be adjusted in the z-direction, in particular by means of a drive device. In order that the imaging device may be moved to the starting position or be adjusted, the provided drive device can, e.g., be the same one that is used for the actual measuring movement, i.e. scanning. Alternatively, different drive devices can be provided for this purpose. For example, the measuring movement can also be provided by means of an eccentric.

The scanning can be performed in particular in increments of 1000 μm or 100 μm, preferably of, e.g., 50 μm, 10 μm or 5 μm. The imaging device can be adjusted, for example, to a maximum speed of 100 mm per second.

In particular, a maximum scanning range of at least 3 cm, 4 cm, 5 cm, 6 cm or more, preferably of 6.5 cm, is enabled in the z-direction. The accuracy in the z-direction can, for example, be 10 μm. In particular, the z-data type can be 16 bits.

A control device is provided, in particular one fitted with a trigger, said device being designed to record an image of a first plane and, after adjustment of the imaging device in the z-direction, to record an image of a second plane. Adjustment of the imaging device can proceed, for example, by means of the same control device. Alternatively, a separate control unit can be provided for this purpose. Preferably, this control unit can be coupled to the control device.

An evaluation device is provided which is designed to interpolate at least one or exactly one sub-plane between the first plane and the second plane.

The evaluation device can, in particular, comprise or consist of a hardware accelerator and/or a multiprocessor architecture, e.g. a GPU or FPGA.

Preferably, a plurality of planes is provided, e.g., at least 3, 4, 5, 6, 7, 8, 9, 10, 20, 30, 40, 50, 60, 70, 80, 90, 100, 150, 200, 250, 300, 400, 500 or more. In particular, a sub-plane can be interpolated between each plane. The planes and/or sub-planes are preferably oriented in parallel with each other. In particular, the planes and/or sub-planes are oriented in parallel and/or are centred in the z-direction.

Surprisingly, it was found that the focus value curve is at least approximately parabolic in shape. Therefore, it is also possible to interpolate values between two, in particular adjacent, planes, i.e. between the discrete scanning points. Increased accuracy can thereby be achieved.

A secondary effect thereof is that it is possible to work with fewer images while retaining accuracy. Insofar, the introduction of sub-planes constitutes not only a gain in accuracy but, above all, also a gain in speed.

Preferably, the evaluation device is designed to evaluate recorded images even as further images are being recorded, and to interpolate the corresponding sub-planes.

Instead of conventional sequential evaluation, it is thus possible for asynchronous evaluation to take place in parallel with the image-recording sequence. The overall effect is to accelerate the evaluation and increase the scanning rate. The clock rate can thus be in the region of two seconds, for example.

The strengths of the system lie particularly in highly performant parallel processing of the vast amount of image data generated per scan, e.g. several gigabytes per scan, as well as in intelligent calculation of the z-information. In this connection, account can also be take of reflection conditions on the component.

Individual components of the device, especially in the area of the image recording, may be black anodised, e.g., in order that undesirable reflections may be avoided.

In particular with the assistance of rapid, robust interpolation algorithms, calculation of the height information is performed to high levels of quality and precision. In addition to the 3D depth image, the device can preferably also provide a superimposed sharp image in the form of a 2D image, which can be used for additional 2D evaluations, such as for lateral measurement functions.

Preferably, inline inspection with a field of view of about 30 mm×24 mm or more for three-dimensional structures is enabled. This allows the entire object to be imaged with a single capture. There is therefore no need in particular to move the object for the purpose of obtaining a complete capture.

Further embodiments of the invention may also be found in the dependent claims, the description and the accompanying drawings.

According to one embodiment, interpolation of the sub-plane is performed pixel by pixel. By virtue of the fact that the sub-plane is calculated pixel by pixel, the surface appears smoother overall.

According to a further embodiment, the interpolation is performed by means of a parabolic fit. A parabolic fit has the advantage of allowing any number of interpolation points to be used to calculate a trend line. This means that there is very little to no loss of accuracy, even where individual outliers occur.

For a parabolic fit, the position of the sharpest pixel in a stack can be detected. The sharpest pixel in both of the overlying and underlying planes can then be determined. A parabolic fit can now be made through the three points. In particular, the planes can be shifted or a shift can be made along the planes in order that the extremum of the three points may be determined.

A parabolic fit is much less labour-intensive than, for example, the calculation of a complex matrix function.

According to a further embodiment, interpolation proceeds by means of a quadratic interpolation. In a quadratic interpolation, preferably only one sub-plane in the range +/−1 plane, proceeding from that main plane which corresponds to a z-index, is interpolated.

According to a further embodiment, a filter, especially a median filter and/or a bilateral filter, preferably a 16-bit median filter, is provided.

A median filter and/or a bilateral filter has a smoothing and simultaneously edge-preserving function. In median filtering or bilateral filtering, all grey values in the filter window are collated and then sorted. The middle element then determines the median and is assigned to the output pixel.

As the calculated height values have 16-bit values after the sub-planes have been calculated and the resulting height image can still have noise and interferences, an efficient 16-bit filter can be used.

Preferably, a performant 16-bit median filter of any filter size is used. In particular, the filter is not limited in terms of either filter size or bit depth.

Due to the different exposure times and/or due to the high number of maximum captures per scan, it is preferable to work with 16-bit image data, especially for the brightness information of a plane and/or for the z-information.

According to a further embodiment, an exposure device is provided which is controlled by means of the control device such that the exposure times for the first plane and the second plane are different. In particular, when there are more than two planes, the exposure times for even indices and odd indices are different.

For example, the exposure device can emit blue, red, white light and/or infrared light. In particular, the exposure device can comprise LEDs.

A depth from focus algorithm does not provide height information in overexposed and/or black areas owing to a lack of necessary texture. In most cases, this is due to the material property of the part being tested. To counteract this, different exposure times are used during image capture.

As a result, all areas can be imaged at least once in good quality and a more complete depth image is obtained overall for test parts that have a high brightness variance on account of reflective surface properties.

In particular, every second image in the image stack is taken at a different exposure time. Thus, an image with a longer exposure time and an image with a shorter exposure time can preferably always be captured in alternation.

For example, the same exposure time can be used for illuminating all even-numbered planes. The same exposure time can also be used to illuminate all odd-numbered planes, with the exposure time for the odd-numbered planes differing from the exposure time for the even-numbered planes.

Especially in combination with a parabolic fit, two captures at different exposure times can be simulated under the same resolution in the z-direction. The processing time here is significantly shorter, as the imaging device only has to be moved once.

Preferably, therefore, each plane is not illuminated separately for two different exposure times, as is the case with conventional High Dynamic Range Imaging (HDRI) methods. However, that is also possible by way of an alternative.

In particular, the intensity of the illumination can be varied. Alternatively, the exposure time of the imaging device can be changed dynamically during a scan. The different brightness information values can then be transformed, especially by means of a suitable transformation function, e.g. a camera response function, into a uniform value space for the purpose of focus calculation. This affords, to a first approximation, a way of obtaining, e.g. 16-bit HDR information across the entire image stack.

The HDRI method as well as the method by which two planes are each exposed differently can capture highly dynamic image content such as dark plastic injection moulding housings in combination with very shiny connector pins. The relevant surfaces are captured in one scan, preferably without affecting the cycle time, by double exposure or by feed-synchronous alternating brightness control.

Even inspection tasks involving large brightness variations in the components which could not be solved up to now, or components having a large dynamic range, can be reliably inspected in this way. Furthermore, not only can coplanarity and/or pin height inspections be performed, but also, for example, solder joint inspections, geometry and/or defect inspections.

Optical inspection of solder joints can be necessary for safeguarding the quality of the electrical contact. Partially or poorly soldered electrical components can lead to errors during subsequent application of the product due to the absence of signal transmission. In addition to complete soldering, the shape and volume of the attached solder are also important for the quality of the solder joint and for electrical transmission.

In accordance with the invention, the solder joints can be imaged three-dimensionally. All quality parameters, in particular, can then be evaluated with just one scan.

In the industrial production of numerous different small and/or very small components, checking of component geometry and/or inspecting for defects can constitute a necessary step within the production chain.

This entails checking compliance with certain limit values in respect of deviations from the standard geometry, such as undesirable residues at injection moulding injection points. Similarly, defects such as broken teeth on small gear wheels, have to be reliably detected. The generated three-dimensional data of the test object enable such defects to be detected reliably and accurately.

According to a further embodiment, the exposure times are optimised by means of automatic parameterisation. In particular, parameterisation may already be carried out in the factory.

As parameterisation is in many cases quite demanding and some parameters have to be determined empirically for each test part, an automatic parameterisation assistant is useful.

In particular, parameterisation can determine the optimal exposure values in full. For example, for the purpose of determining the exposure time, images are continually captured until only a few, if any, overdriven grey values occur, e.g. 0 or 255 in the case of 8-bit images.

An autotune function can be used, for example, to run through different exposure times. In particular, this is an iterative process. The confidence values can be determined via the surface area. That exposure time at which the least number of grey, unusable pixels occur can then be selected.

The optimal exposure times for the first plane and the second plane can be determined independently of each other. Typical exposure times are in the range, e.g. 0.001 s and 0.1 s. For example, the exposure time can be 0.015 seconds for the first layer and 0.03 seconds for the second.

According to a further embodiment, the control device only captures partial areas of the first plane and/or the second plane. In particular, this approach captures less data from the outset.

Alternatively or additionally, the evaluation device only evaluates partial areas of the first plane and/or the second plane.

Often only small partial areas of a test object, called multi-areas of interest (AOI), are of interest, e.g. the pin heights of a connector and/or an associated reference surface. In most cases, these surfaces occupy only a portion of the camera image, but are scattered across the entire image. In order that the calculation time and thus the total cycle time for the evaluation may be kept low, in particular only the partial areas of interest are marked as such and/or the images are evaluated only within these partial areas.

In particular, the AOI can comprise, for example, 20 megapixels. For example, specific lines in a chip can be limited and/or not all data may be output.

Selection of the areas can be done in particular by means of automated parameterisation.

Parameterisation can in particular determine all of the required scanning areas. The scanning areas can be determined in the AOI via the focus value curve. In particular, for each pixel in an area of the AOI, there must be a peak present in the curve.

According to a further embodiment, where there is a plurality of planes, the control device only captures images of certain planes. Therefore, preferably not all planes are captured.

Alternatively or additionally, where there is a plurality of layers, the evaluation device evaluates only images of certain layers.

In so-called multi-layer scans, several areas of an object are scanned in the z-direction. In order to make this performant, the area in question can be limited to such an extent that only those features are scanned which are of interest. Thus, an image is not created in every z-position.

For example, if the reference surface during a pin-height inspection is on a different plane from the pins themselves, then in principle two scans can be made at different z-positions. The offset of the two scanning planes can be factored because the distance is known, as a result of which a single height image is created without the need to capture images between the planes.

Selection of the planes can be done in particular by means of automated parameterisation.

In particular, a two-dimensional image can be captured first in order that the exact position of the object may be determined.

Especially through a combination of multi-AOI and multi-layer capture, three-dimensional cuboids are generated within which a calculation takes place. Areas outside these regions can be ignored.

The invention also concerns a method for detecting a three-dimensional structure with an inventive device, in which an image of a first plane is recorded, the imaging device, in particular the camera, is adjusted in the z-direction and an image of a second plane is recorded.

A sub-plane is interpolated between the first plane and the second plane. The sub-plane calculated between the first and the second plane can, in particular, increase the accuracy and/or the speed.

According to one embodiment, image capture and evaluation are performed in parallel. In this way, the speed of evaluation can be further increased.

According to a further embodiment, the exposure time or different exposure times can be optimised by means of automated parameterisation.

Alternatively or additionally, automated parameterisation can be used to select relevant partial-areas and/or relevant planes. Areas outside these regions can be ignored. In this way, the speed of the evaluation can be further increased.

All embodiments and components of the device described herein are in particular designed to be operated, e.g., by means of a control device, in accordance with the method described herein. Furthermore, all embodiments of the device described herein and all embodiments of the method described herein can each be combined with one another, especially also separately from the specific embodiment in which they are mentioned.

The invention is described below by way of example with reference to the drawings. The drawings show in:

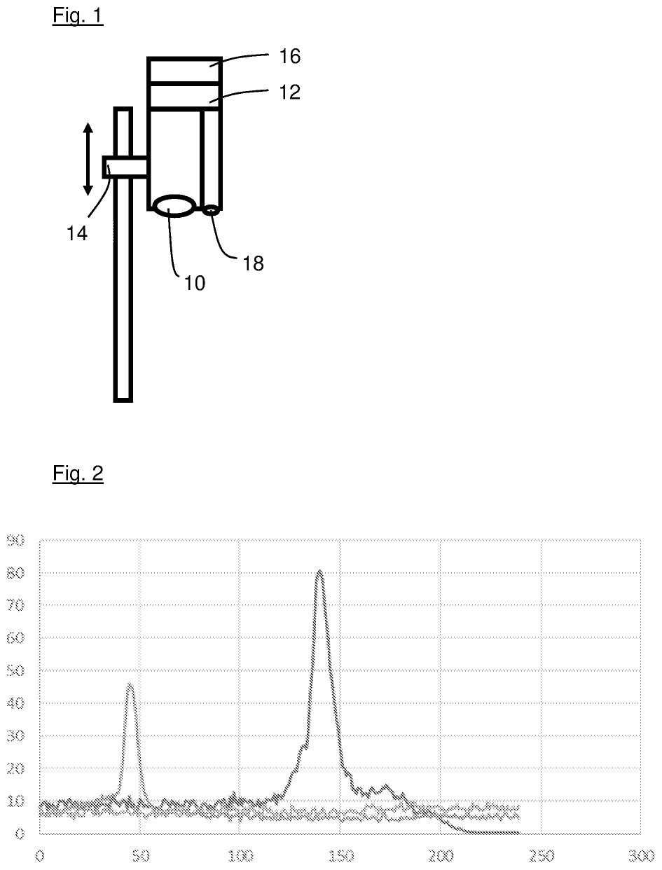

FIG. 1 A cross-sectional view of an embodiment of an inventive device.

FIG. 2 a focus value curve in three different pixels,

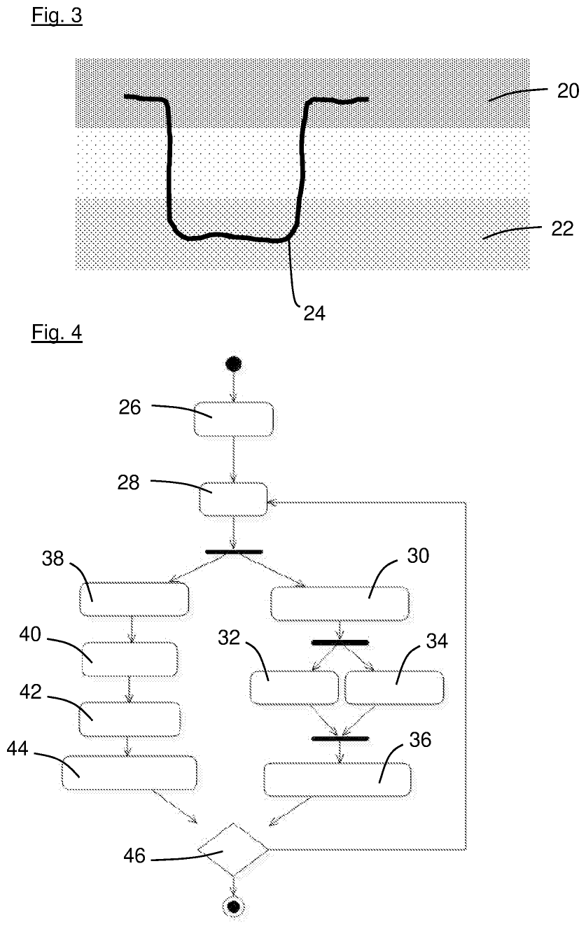

FIG. 3 A height image of a multi-layer scan, and

FIG. 4 A flow chart of an asynchronous evaluation in parallel with the image capture sequence.

First of all, it should be noted that the embodiments shown are purely exemplary. Thus, individual features can be realised not only in the combination shown, but also alone or in other technically useful combinations. For example, the features of one embodiment can be combined as desired with features of another embodiment.

Where a drawing contains a reference numeral which is not explained in the directly associated descriptive text, reference is made to the corresponding previous or subsequent deliberations in the description of the drawings. Thus, the same reference numerals are used for the same or comparable components in the drawings and are not explained again.

FIG. 1 shows a device for capturing a three-dimensional structure with a camera 10 which is adjustable in the z-direction (see double arrow) and constitutes the imaging device.

The device comprises a control device 12 which can capture images in different planes by means of the camera 10. The camera 10 can be adjusted in the z-direction by means of a drive device 14, whereby an image is captured at each of certain predetermined intervals.

Furthermore, the device comprises an evaluation device 16, which calculates a sub-plane between each of the captured planes.

An exposure device 18 can be used to expose the images in the individual planes. In particular, the planes can be exposed alternately at different exposure times, whereby each plane is preferably exposed at only one exposure time. In this way, for example, bright components can be shown in one layer and dark components in the next layer.

Through interpolation, all components can then be clearly visible in a composite image.

FIG. 2 shows a focus value curve in three different pixels, with the z-direction plotted on the x-axis and the focus value on the y-axis.

The shape of the focus value curve is parabolic. Proceeding therefrom, it is also possible to interpolate values between the discrete scanning points and to obtain increased accuracy.

FIG. 3 shows a possible curve of a multi-layer scan.

For example, if the reference surface during a pin height inspection is on a different plane from the pins themselves, then in principle two scans can be made at different z-positions. The offset of the first scan area 20 and the second scan area 22 can be factored in because the distance is known.

In particular, scanning does not take place between the first scanning area 20 and the second scanning area 22. Nevertheless, a height image 24 can be generated.

Finally, FIG. 4 shows a flow chart for asynchronous evaluation in parallel with the image capture sequence.

To boost performance, the image data are preprocessed asynchronously while the scanning process is in progress.

First, initialisation 26 takes place, and then the scan is started 28.

The capture process is started 30. Now the axis is moved 32. While this is in progress, images are captured 34. Finally, the capture process is finished 36.

In parallel with the capture process, processing is started 38. The images are processed 40 and a depth image is created 42. Finally, the depth image can optionally be enhanced 44.

Finally, a new scan 46 can be started, as required.

### LIST OF REFERENCE SYMBOLS

10 Camera, imaging device
12 Control device
14 Drive device
16 Evaluation device
18 Exposure device
20 First scanning area
22 Second scanning area
24 Height image
26 Initialisation
28 Start scan
30 Start capture
32 Move axis
34 Image capture
36 End capture process
38 Start processing
40 Process images
42 Generate depth image
44 Improve depth image
46 New scan

1. Device for detecting a three-dimensional structure,
comprising
an imaging device (10), which is adjustable in the z-direction,
a control device (12) which is designed to record an image of a first plane and, after adjustment of the imaging device (10) in the z-direction, to record an image of a second plane, and
an evaluation device (16) which is designed to interpolate a sub-plane between the first plane and the second plane.

2. Device according to claim 1,
characterised in that
interpolation of the sub-plane proceeds pixel by pixel.

3. Device according to claim 1,
characterised in that
interpolation proceeds by means of a parabolic fit.

4. Device according to claim 1,
characterised in that
interpolation proceeds by means of a quadratic interpolation.

5. Device according to claim 1,
characterised in that
a filter is provided.

6. Device according to claim 1,
characterised in that
an exposure device is provided which is controlled by means of the control device such that the exposure times for the first plane and the second plane are different.

7. Device according to claim 1,
characterised in that
the exposure times are optimised by means of automated parameterisation.

8. Device according to claim 1,
characterised in that
the control device (12) records only partial areas of the first plane and/or the second plane.

9. Device according to claim 1,
characterised in that
the control device (12) records only images of certain planes in the event that there is a plurality of planes, and/or
the evaluation device (16) evaluates only images of certain planes in the event that there is a plurality of planes.

10. Method for detecting a three-dimensional structure,
comprising a device in accordance with any of the preceding claims, in which an image is recorded of a first plane,
the imaging device (10) is adjusted in the z-direction,
an image is recorded of a second plane, and
a sub-plane is interpolated between the first plane and the second plane.

11. Method according to claim 10,
characterised in that
image capture and evaluation are performed in parallel.

12. Device according to claim 1,
characterised in that
the imaging device (10) is a camera.

13. Device according to claim 5,
characterised in that
the filter is a 16-bit median filter.

14. Device according to claim 1,
characterised in that
the evaluation device (16) evaluates only partial areas of the first plane and/or the second plane.
